(19) United States
(12) Patent Application Publication
(10) Pub. No.: US 2016/0067134 A1
(43) Pub. Date: Mar. 10, 2016

(54) REMOTE CONTROL HOUSING SYSTEMS, DEVICES, AND METHODS, AND PROTECTIVE COVERS FOR REMOTE CONTROLS

(71) Applicants: Roger S. Moon, Selden, NY (US); Slawomir Oleszak, East Setauket, NY (US)

(72) Inventors: Roger S. Moon, Selden, NY (US); Slawomir Oleszak, East Setauket, NY (US)

(21) Appl. No.: 14/845,316

(22) Filed: Sep. 4, 2015

Related U.S. Application Data
(60) Provisional application No. 62/046,204, filed on Sep. 5, 2014.

(51) Int. Cl. A61G 13/10; A61G 13/02

(52) U.S. Cl. CPC A61G 13/101; A61G 13/02

(57) ABSTRACT

A cover device for a remote control device comprises an anterior wall defining a central opening therein, a posterior wall formed of two ledges and defining a gap therein, a first lateral wall connected to the anterior wall and the posterior wall, a second lateral wall connected to the anterior wall and the posterior wall, a superior wall connected to the anterior wall, the posterior wall, the first lateral wall, and the second lateral wall, and a door hingedly connected to the anterior wall. The cover device may further comprise two overhangs connected to one of the lateral walls, and the two overhangs may define a rail slot. The cover device may be slidably attachable to a side rail of a surgical table via the rail slot. A remote control device is slidably insertable into the remote control cover device.

### CROSS-REFERENCE TO RELATED APPLICATION

This application is a non-provisional of and claims priority to U.S. Patent Application Ser. No. 62/046,204, filed Sep. 5, 2014, which is hereby incorporated by reference in its entirety.

### FIELD

The present disclosure relates to remote control housing systems, devices, and methods. The present disclosure further relates to protective covers for remote control units used in medical procedures.

### BACKGROUND

Operating room tables are often operated by remote controls, rather than being positioned manually. During surgery, the remote controls are operated primarily by anesthesiologists. Robotic and laparoscopic surgeries have become increasingly common and are performed in increasingly high volumes because they are deemed to be less invasive, and they allow faster recovery times, decreased length of hospital stay, and have a higher rate of overall patient satisfaction.

Their popularity also stems from the idea that they promote patient safety, which is not supported by studies. In fact, their growth has been associated with a number of case reports of preventable devastating injuries due to patient malpositioning. An example is patient movement during robotic or laparoscopic surgery due to accidental surgical bed repositioning. It is well known that the surgical bed functions separately from a surgical robot, or a performing surgeon. While procedures in the abdomen may require minimal patient movement, even the slightest movements are not tolerated in surgeries pertaining to the intracranial or mediastinal compartment. The consequences are devastating, including possible death of the patient. Furthermore, many remote controls for surgical tables do not have a lock function preventing unintentional use. Moreover, the buttons on the remote control are unprotected and are easily activated accidentally during surgery.

In addition, robotic and laparoscopic surgery presents a unique risk to the patient due to the nature of instruments placed through ports, which cannot be moved once placed. It is an absolute requirement that the patient be paralyzed and under general anesthesia for this reason. A case report involves a 54-year-old male undergoing a laparoscopic kidney resection. The patient was pharmacologically paralyzed and placed under general anesthesia, which was appropriate for this surgery. Rigid steel instruments were placed into abdominal cavity through small abdominal skin incisions.

After placement of surgical instruments, resection of the kidney began. The anesthesiologist reached under the surgical table to quantify the urine output. During this time, there was an accidental deployment of a button on the surgical table remote control by the anesthesiologist. The button initiated a sudden, rapid airplane rotation of the surgical table and the patient was inadvertently moved away from the surgeon during active resection. The surgeon quickly recognized the situation and moved himself with the rotating patient while keeping the trocars in place. The patient was not harmed during this event.

Existing remote control covers have a number of disadvantages. For instance, some models do not include an opening for a remote control clip to attach the device to the machine it controls, for example, a surgical table. Some models lack a slide-in function which allows installation with a single hand and/or allows the remote control protective cover unit to be in plane with the machine it controls.

Remote controls are a ubiquitous source of infection between patients in the operating room. They are often exposed to human bodily fluid such as blood, urine, and saliva during surgery and are not regularly cleaned between cases. One existing solution is for the remote control to be wrapped to prevent the spread of infection. Although this might provide a secure barrier for the remote, it fails to protect against the unintentional use of the remote control, for example, by inadvertent activation of the remote push buttons. The barrier function is primarily protecting against the spread of pathogens through direct contact. It also lacks the function of protecting the remote control from direct damage.

Another existing solution includes the ability of activating the buttons with the cover in place, with a primary function to protect the remote control buttons from damaging liquid and food products. Remote control buttons are depressible while the cover is in place, made possible by a top panel with holes accommodating the push buttons. Accordingly, this device does not protect against inadvertent activation of the buttons.

Thus, there is a need for a cover for a remote control that prevents both the spread of pathogens and the unintentional use of the remote control. There is also a need for a protective cover device designed for surgical patients for use in the operating room (“OR”). Accordingly, there is a need for a single-use, disposable protective cover for a remote control used in medical procedures that prevents inadvertent activation of the buttons of the remote control and is easily installed.

### SUMMARY

Exemplary embodiments of the present disclosure alleviate to a great extent the disadvantages of known remote control covers by providing a protective cover for a remote control used for an operating room (OR) table which is designed to prevent patient harm caused by unintentional patient repositioning during surgery. The protective cover for a remote control used for the operating room table is designed to prevent unintentional patient movement during high risk surgeries including, but not limited to, laparoscopic or robotic surgery. Throughout the present disclosure and claims, the terms “cover,” “protective cover,” “cover device” and “remote control cover device” may be used interchangeably to mean a device that covers, houses, and/or protects a remote control device.

In exemplary embodiments, the device is equipped with a door, and slides to accommodate a remote control. It allows the remote control functions to be deployed only when the door is open. It also has the ability to measure the amount of rotation of the bed, offering quantifiable methods to determine a patient's position. The hand-held device may be rectangular and may undergo a sliding mechanism to accommodate the remote control. It may be disposable, and may be composed of transparent, rigid, water resistant, and/or shatter resistant material. The cover may have a door function that permits activation of the remote control buttons only when the door is open. Through a sliding function onto a surgical bed side rail, it also carries the ability to measure the amount of rotation of the bed, allowing one to quantify a patient's position during surgery.

Additional objects of the disclosure include providing a disposable rigid cover which protects against inadvertent deployment of surgical table repositioning during surgery in the operating room, a gap located on the protective cover which allows a slide-in, single hand loading ability of the remote, the ability to preserve the function of a clip-on remote control on an operating room table rail, grooves on the protective cover which ensure that the protective cover-remote unit can stay in a closed position, accommodation of a sterile cover, a slide-in port accommodating the side rail which allows the protective cover-remote unit to be level relative to the surgical bed and allows for user-friendliness, and a built-in device used to measure the degree of rotation of the bed relative to the operating room floor.

In exemplary embodiments, a cover for a remote control comprises an anterior wall, a posterior wall, first and second lateral walls, and a superior wall connected to the anterior wall, the posterior wall, the first lateral wall, and the second lateral wall. The anterior wall defines a central opening therein. The posterior wall includes two ledges and defines a gap therein. The two lateral walls are each connected to the anterior wall and the posterior wall. A door is hingedly connected to the anterior wall. In exemplary embodiments, the cover further comprises two overhangs connected to one of the lateral walls, and the two overhangs may define a rail slot. The gap may be sized to accommodate a clip attached to a posterior wall of a remote control, and the clip may be located at the gap when the remote control is inserted into the cover.

Exemplary embodiments of a cover device for a remote control device comprise an anterior wall defining a central opening therein, a posterior wall formed of two ledges and defining a gap therein, a first lateral wall connected to the anterior wall and the posterior wall, a second lateral wall connected to the anterior wall and the posterior wall, a superior wall connected to the anterior wall, the posterior wall, the first lateral wall, and the second lateral wall, and a door hingedly connected to the anterior wall. In exemplary embodiments, one or more of the anterior wall, posterior wall, lateral walls, and door are made of a sterile material. The gap may be sized to accommodate a clip on a remote control device. Exemplary embodiments further comprise a remote control device for a surgical table. The remote control device may be slidably insertable into the cover device.

In exemplary embodiments, the cover device further comprises two overhangs connected to one of the lateral walls, and the two overhangs define a rail slot. The rail slot may be sized to accommodate a surgical bed side rail. Exemplary embodiments further comprise a surgical bed having at least one side rail, and the cover device is slidably attachable to the side rail via the rail slot.

Exemplary embodiments of a remote control housing system comprise a remote control cover device and a surgical bed. The remote control cover device includes an anterior wall defining a central opening therein, a posterior wall including two ledges and defining a gap therein, a first lateral wall connected to the anterior wall and the posterior wall, a second lateral wall connected to the anterior wall and the posterior wall, a superior wall connected to the anterior wall, the posterior wall, the first lateral wall, and the second lateral wall, a door hingedly connected to the anterior wall, and two overhangs connected to one of the lateral walls, the overhangs defining a rail slot.

The surgical bed has at least one side rail, and the remote control cover device is slidably attachable to the side rail via the rail slot. In exemplary embodiments, the system further comprises a remote control device that is slidably insertable into the remote control cover device. The remote control device may have a posterior wall and comprise a clip attached to its posterior wall. In exemplary embodiments, the gap in the posterior wall of the remote control cover device sized to accommodate the clip.

Exemplary methods of using a remote control device comprise providing a remote control cover device and coupling the remote control cover device to a surgical bed. The remote control cover device may include an anterior wall defining a central opening therein, a posterior wall including two ledges and defining a gap therein, a first lateral wall connected to the anterior wall and the posterior wall, a second lateral wall connected to the anterior wall and the posterior wall, a superior wall connected to the anterior wall, the posterior wall, the first lateral wall, and the second lateral wall. a door hingedly connected to the anterior wall, and two overhangs connected to one of the lateral walls. The overhangs define a rail slot, and the surgical bed has at least one side rail. Coupling the remote control cover device to the surgical bed comprises sliding the rail slot onto the side rail.

Exemplary methods further comprise sliding a remote control device into the remote control cover device. Exemplary methods of using a remote control device comprise opening the door of the remote control cover device and activating one or more buttons of the remote control device to move the surgical bed.

Accordingly, it is seen that remote control cover devices, systems, and methods are provided which are convenient to use and prevent unintentional patient movement. These and other features of embodiments of the present disclosure will be appreciated from review of the following detailed description of exemplary embodiments, along with the accompanying figures in which like reference numbers refer to like parts throughout.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a top view of an exemplary embodiment of a remote control cover device in accordance with the present disclosure;

FIG. 2 is a bottom view of an exemplary embodiment of a remote control cover device in accordance with the present disclosure;

FIG. 3 is a front perspective view of an exemplary embodiment of a remote control cover device in accordance with the present disclosure;

FIG. 4A is a first side view of an exemplary embodiment of a remote control cover device in accordance with the present disclosure;

FIG. 4B is a second side view of the remote control cover device of FIG. 4A;

FIG. 5A is a front perspective view of an exemplary embodiment of a remote control device used with a remote control cover device in accordance with the present disclosure;

FIG. 5B is a rear perspective view of the remote control device of FIG. 5A;

FIG. 6A is a front perspective view of an exemplary embodiment of a remote control housing system and method in accordance with the present disclosure;

FIG. 6B is a front perspective view of an exemplary embodiment of a remote control housing system and method in accordance with the present disclosure;

FIG. 6C is a rear perspective view of an exemplary embodiment of a protective cover-remote unit in accordance with the present disclosure;

FIG. 7 is a front perspective view of an exemplary embodiment of a protective cover-remote unit in accordance with the present disclosure;

FIG. 8 is a perspective view of an exemplary embodiment of a remote control housing system and method in accordance with the present disclosure;

FIG. 9A is a top view of an exemplary embodiment of a remote control housing system and method in accordance with the present disclosure;

FIG. 9B is a top view of an exemplary embodiment of a remote control housing system and method in accordance with the present disclosure;

FIG. 10 is a perspective view of an exemplary embodiment of a remote control housing system and method in accordance with the present disclosure;

FIG. 11 is a perspective view of an exemplary embodiment of a protective cover-remote unit with a protective film applicator in accordance with the present disclosure;

FIG. 12 is a perspective view of an exemplary embodiment of a roll of protective film in accordance with the present disclosure;

FIG. 13 is a perspective view of an exemplary embodiment of a remote control housing system and method with a protective film applicator in accordance with the present disclosure;

FIG. 14A is a top perspective view of an exemplary embodiment of a remote control cover device in accordance with the present disclosure;

FIG. 14B is a top perspective view of an exemplary embodiment of a remote control cover device in accordance with the present disclosure;

FIG. 14C is a side view of an exemplary embodiment of a remote control cover device in accordance with the present disclosure;

FIG. 15 is a perspective view of an exemplary embodiment of a protective cover-remote unit in accordance with the present disclosure;

FIG. 16 is a perspective view of an exemplary embodiment of a protective cover-remote unit with a protective film applicator in accordance with the present disclosure;

FIG. 17 is a perspective view of an exemplary embodiment of a roll of protective film in accordance with the present disclosure; and

FIG. 18 is a perspective view of an exemplary embodiment of a roll of protective film in accordance with the present disclosure.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure. As used herein, the “present disclosure” refers to any one of the embodiments described herein, and any equivalents. Furthermore, reference to various aspects of the disclosure throughout this document does not mean that all claimed embodiments or methods must include the referenced aspects.

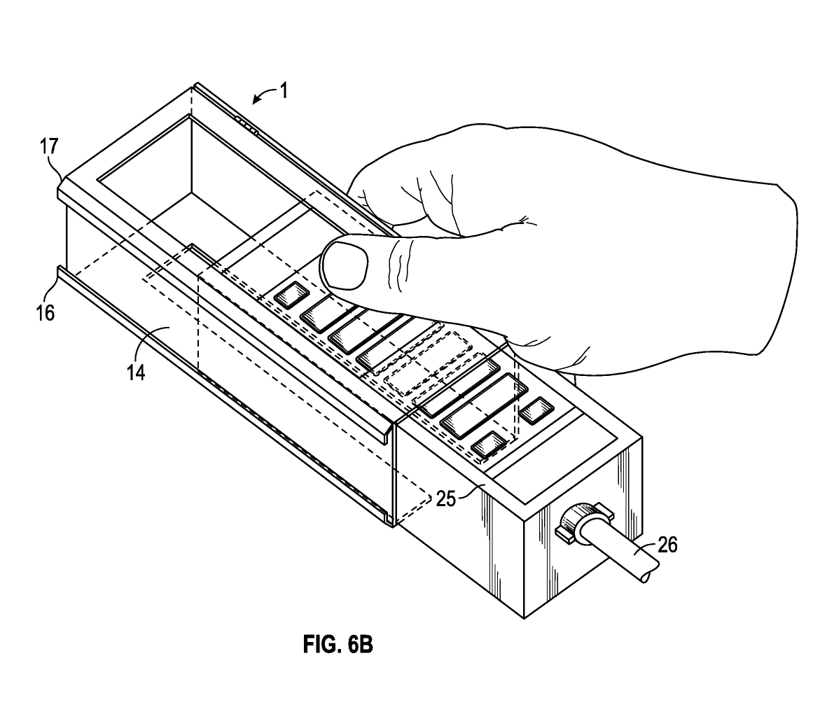

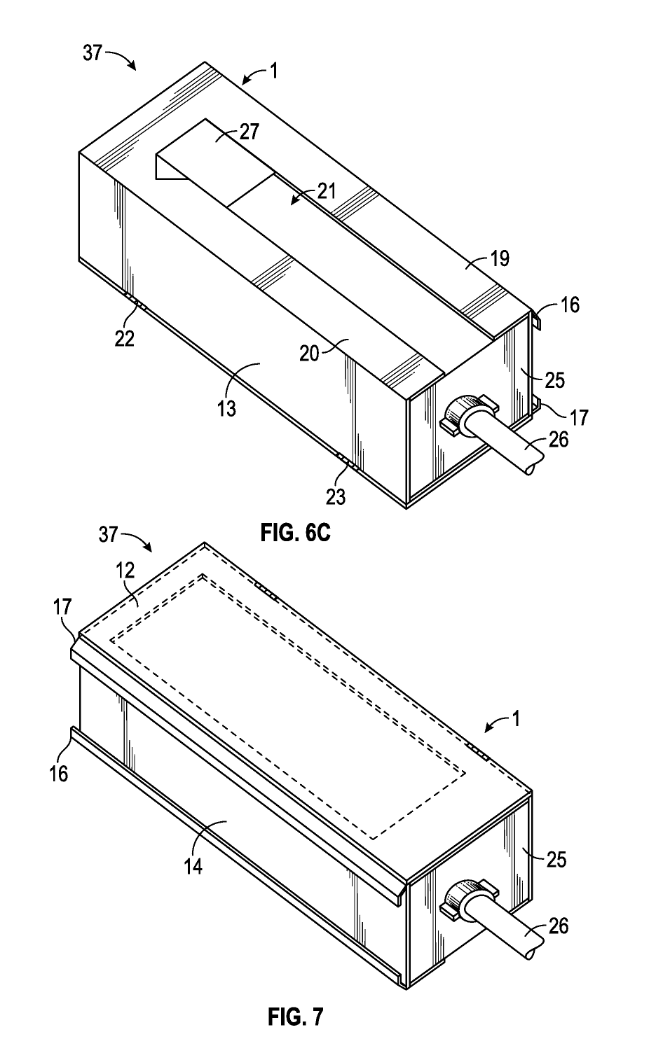

Exemplary embodiments and functionality of a remote control cover device are described herein. An exemplary protective cover is equipped with a door and a posteriorly located slide-in gap to accommodate a posterior clip existing on the surgical table remote control device. As discussed in more detail herein in connection with FIGS. 6A and 6B, the remote control device may slide into the cover from top to bottom, allowing for a single hand installation. The slide-in gap also allows the protective cover-remote unit to preserve its function to be secured on a surgical table side rail. An exemplary protective cover may be made of one or more of various types of materials, including but not limited to, sterile material, disposable material, transparent material, water-resistant material, and/or shatter-resistant material for its use in the OR.

In exemplary embodiments, the protective cover is designed to be used by one hand and the buttons are protected by a door. The buttons of the remote control are contained and protected from activation when the cover-remote unit is closed. Buttons are accessible and able to be activated when the door is open. In exemplary embodiments, the door is opened from right to left with a hinge on the right, but other arrangements are possible, such as left to right, and opening from the top or bottom edges.

Referring to FIGS. 1-4B, exemplary embodiments of a remote control cover device will be described. FIG. 1 shows a top view of an exemplary embodiment of a protective cover. The cover 1 has a door 12, and is composed of four major walls. The walls include an anterior wall 18, along with two lateral walls 13, 14, and a posterior wall 15. The posterior wall 15 is formed of two ledges 19, 20 and defines a gap 21 in between the ledges. As discussed in more detail herein, gap 21 defined by ledges 19, 20 in posterior wall 15 is sized to accommodate a remote control clip.

The first lateral wall 13 is connected to and bridges anterior wall 18 and posterior wall 20. The second lateral wall 14 is connected to and bridges anterior wall 18 and posterior wall 20 on the other side of the cover device 1. A superior wall 24 may be attached to the other walls 13, 14, 15, 18, 19, and 20 that make up the cover 1, giving it an overall rectangular-like shape. However, embodiments need not have a superior wall. More particularly, this construction gives cover 1 a substantially rectangular shape and cross-section, though other shapes could be utilized for differently shaped remote control devices. In exemplary embodiments, the cover device 1 has no bottom wall. Rather, it has an open bottom 38 to provide access for and slidable installation of the remote control. The open bottom 38 also allows exposure of and access to wire 26 of the remote control 25 so the remote can be connected as necessary to make it fully operational.

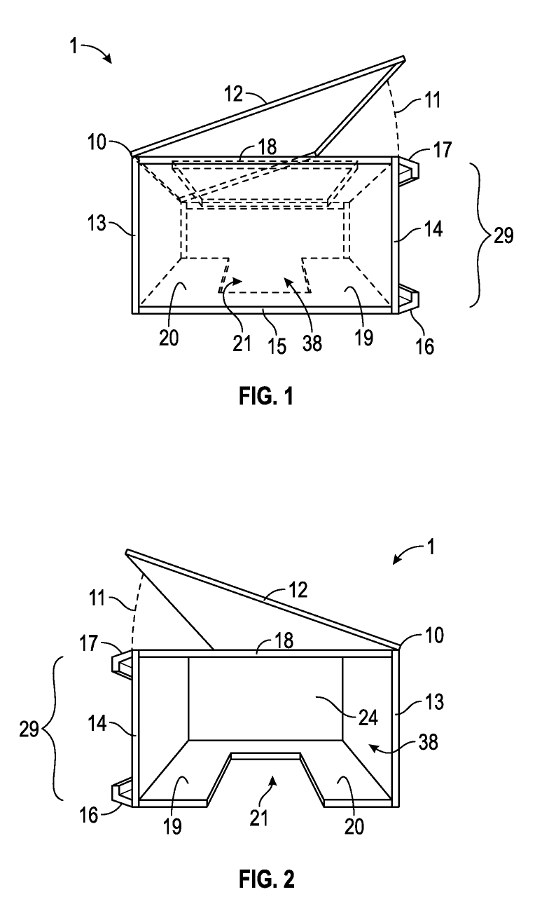

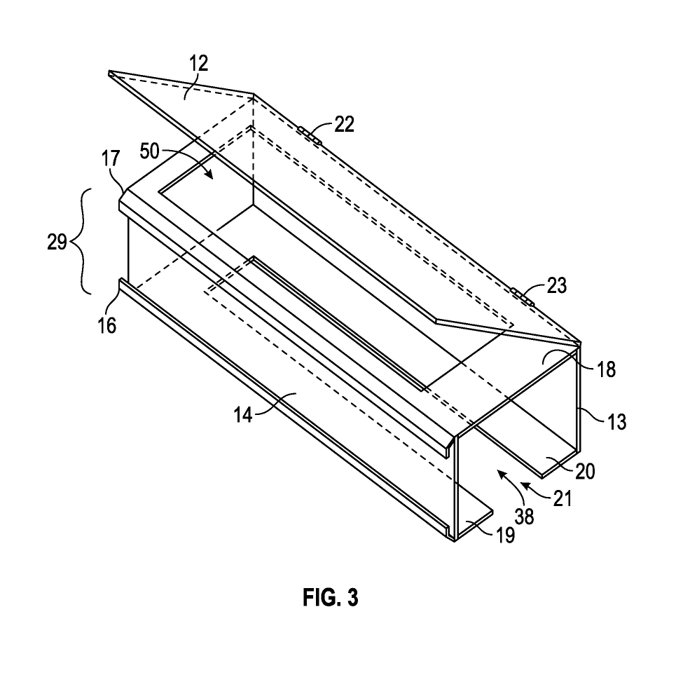

As best seen in FIGS. 1 and 2, exemplary embodiments have two overhangs 16, 17 connected to one of the lateral walls 13, 14. By way of example, the overhangs 16, 17 are shown attached to the second lateral wall 14, but the overhangs could be attached to the first lateral wall 13 in addition to or instead of to the second lateral wall 14. A rail slot 29 is defined by the two overhangs 16, 17. In other words, the two overhangs 16, 17 define the rail slot 29. In FIG. 3A, the rail slot 29 is seen anteriorly with overhangs 16, 17 located on the right lateral wall 14. The rail slot 29 could be defined by continuous overhangs extending the full length of a lateral wall of the remote control cover device. Alternatively, there could be multiple small discrete overhang components spaced out along the cover at two or more locations along a lateral wall, with the multiple overhang components defining the rail slot. As discussed in more detail herein, rail slot 29 serves to accommodate a surgical bed side rail.

As best seen in FIG. 3, the anterior wall 18 defines a central opening 50. The central opening 50 extends through a substantial area of anterior wall 18. The central opening 50 may be substantially rectangular or any other shape to best provide access to the remote control device when the remote control is housed within the cover 1. A door 12 is hingedly connected to the anterior wall 18 by any number of hinges. In exemplary embodiments, the cover 1 has two hinges 22, 23 that connect the door 12 to the anterior wall 18 and serve to accommodate the opening/closing function 11 of the door 12, as best seen in FIG. 2. The point 10 at which the door 12 and the anterior wall 18 meet is created through the support of the two hinges 22, 23.

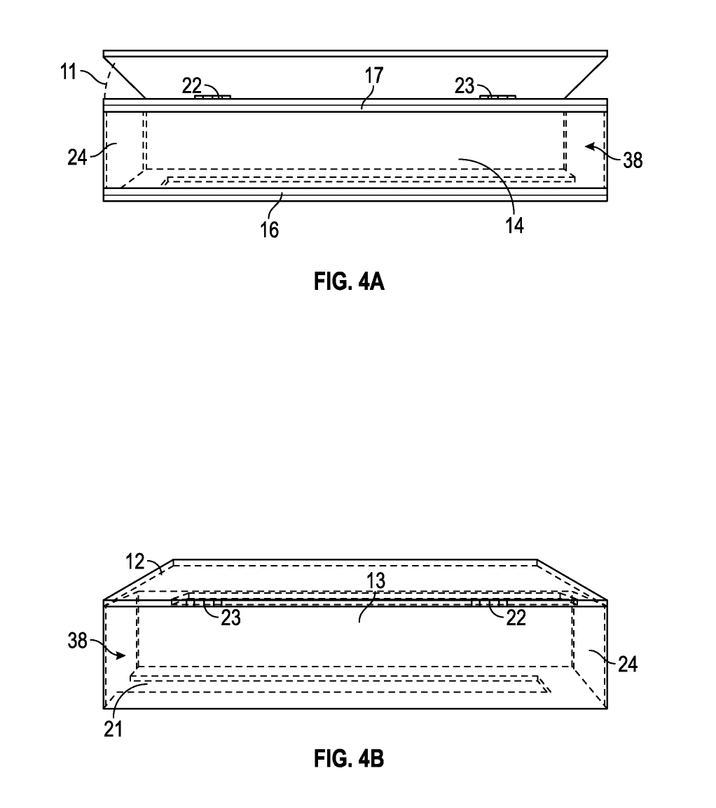

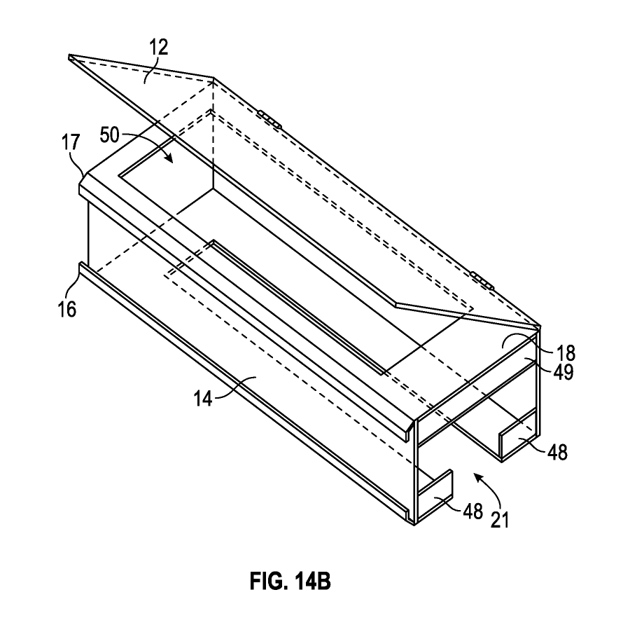

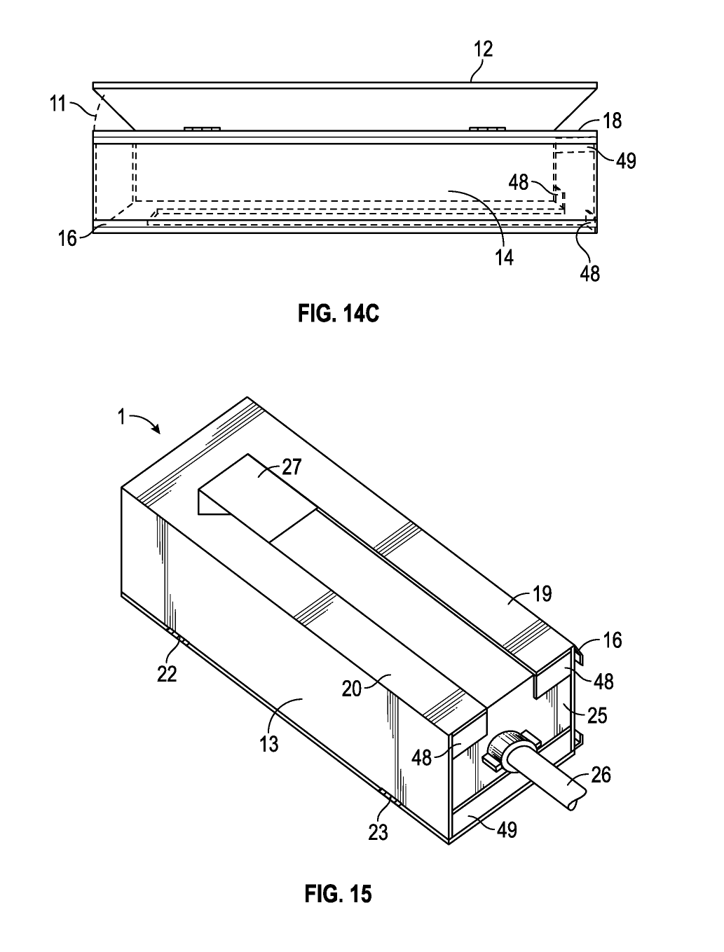

FIGS. 4A and 4B show horizontal views with the hinges 22, 23 at distal and proximal positions, respectively. FIG. 4A shows a side view of the opening 11 of door 12 of the remote control cover device 1, i.e., the door 12 in an open position. By contrast, FIG. 4B shows an opposite side view of the door 12 in the closed position. When the door 12 is in an open position, the central opening 50 defined in the anterior wall 18 of the cover 1 allows the user to access the buttons of a remote control device housed in the cover. In exemplary embodiments illustrated in FIGS. 14A-14C, one or more small flanges 48 may be provided perpendicular to ledges 19 and 20 and/or a large flange 49 perpendicular to anterior wall 18 to ensure that the remote control does not fall out of the cover while in use.

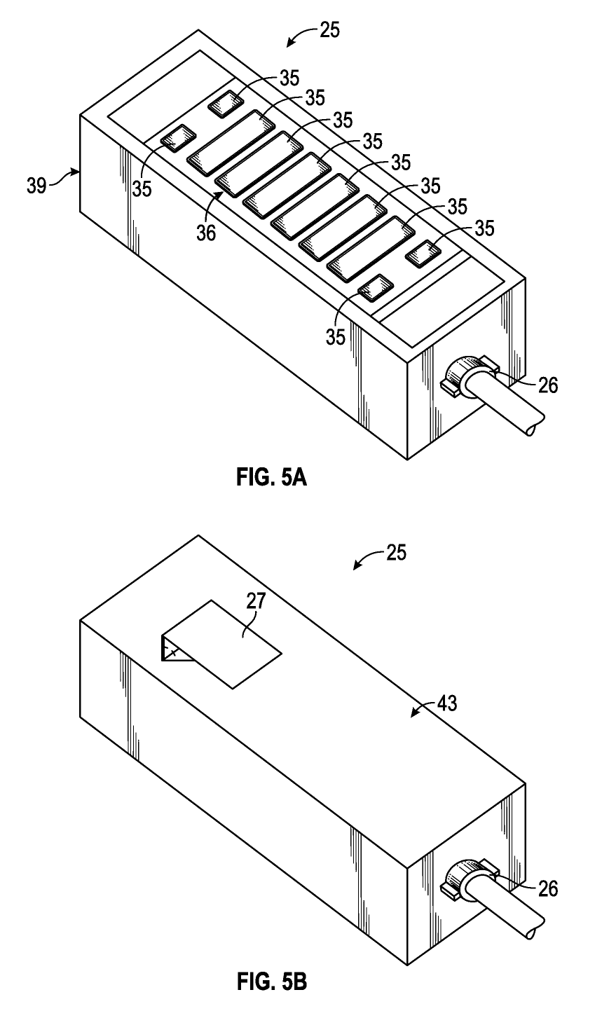

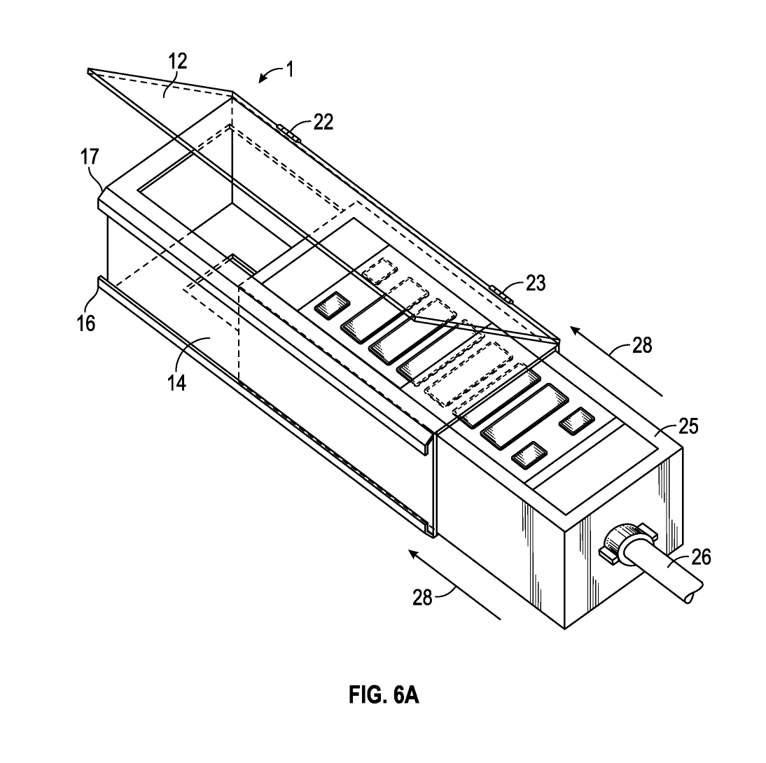

Turning to FIGS. 5A-5B, an exemplary remote control device 25 appropriate for use with an exemplary protective cover 1 is shown. Depressible buttons 35 are present on the anterior face 36 of the remote control 25. The remote control device 25 may have a wireless connection or may be connected by wire 26 to a surgical bed. As best seen in FIG. 5B, the remote control device 25 may have a clip 27, more particularly a surgical bed clip to clip the remote 25 to the bed.

FIGS. 6A and 6B illustrate the sliding installation 28 of the remote control device 25 into the remote control cover device 1. More particularly, the slidable fit of the remote control device 25 into the cover 1 advantageously enables the user to easily slide the remote control 25 into the protective cover 1 using only one hand. In operation, the user grasps the cover 1 and positions it so the open bottom 38 is lined up with the front end 39 of the remote control 25. The user may then use either a finger or thumb to slide the cover device 1 over the remote control 25 or the remote control into the cover. As illustrated in FIG. 6C, during and after the sliding installation 28, clip 27 of the remote 25 is accommodated by the gap 21 in the protective cover 1. This one-hand sliding installation 28 is a significant advantage for surgeons and other medical professionals so they can fit the remote control 25 into the protective cover 1 quickly and easily and while handling other surgical instruments if necessary.

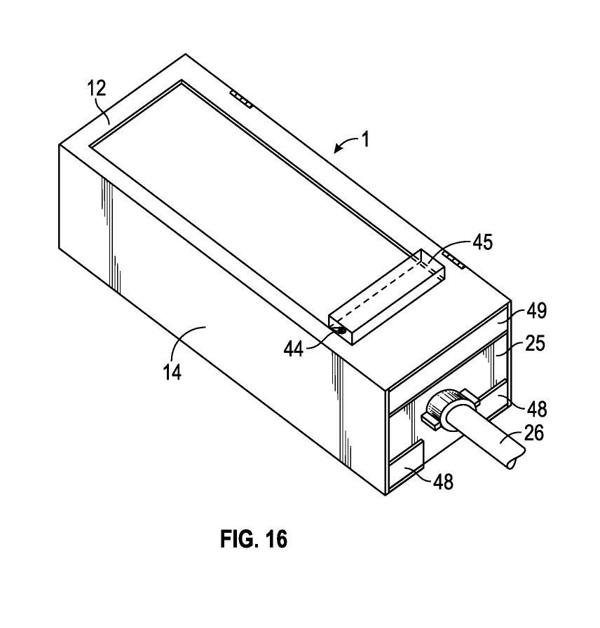

With reference to FIG. 7, once the remote control device 25 is slidably inserted into the protective cover device 1, the two devices together comprise a cover-remote unit 37. The opening and closing of the door 12 and the operation of the remote 25 by activating buttons 35 can be operated by a single hand of the user, while preserving the shape of the handheld remote 25 without adding significant size. In operation, the user holds the cover-remote unit 37 in one hand and can use either a single finger or thumb manipulating an edge of the door 12 to open the door and access the buttons 35. Once the desired button activation and corresponding movement of the surgical table or bed is accomplished, the user then can use the same finger or thumb to move the door 12 back to a closed position, thereby protecting against inadvertent activation of any buttons 35 of the remote 25. As illustrated in FIGS. 15 and 16, small flanges 48 and/or large flange 49 ensure that the remote control does not fall out of the cover while in use.

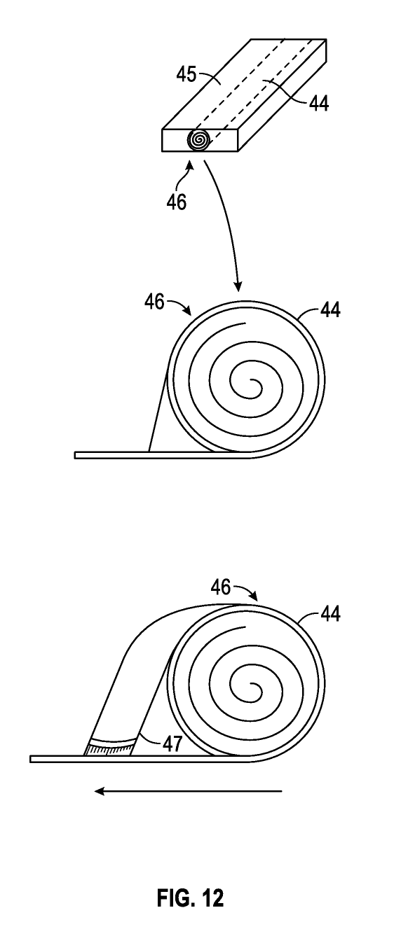

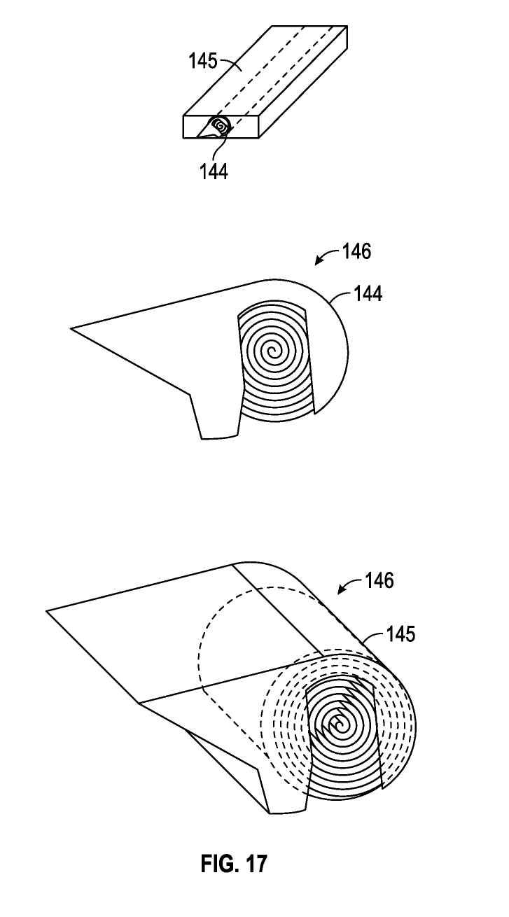

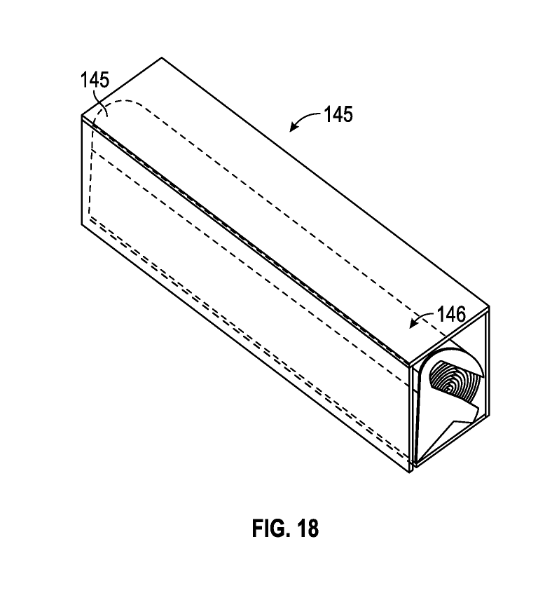

In exemplary embodiments, a remote control cover may include certain features to address the infectious spread of pathogens. These features could make the cover device compliant with Department of Health requirements and therefore make the utility of the cover device much greater. Referring to FIGS. 11-13 and 16-18, exemplary embodiments may have a sterile/clean, adherent, transparent “tegaderm” like film 44, 144 that can be “rolled” onto the anterior face 36 of the parent remote, including an applicator 45, 145 on the cover device 1 that allows this. The film 44, 144 may come pre-installed in a roll 46, 146 onto the remote control cover 1 in the applicator 45, 145. The film itself may be made of similar material as that used in screen scratch protectors for mobile phones. In exemplary embodiments, one side of the film 45, 145 is adhesive 47, and provides a barrier that does not inhibit the pushing of buttons.

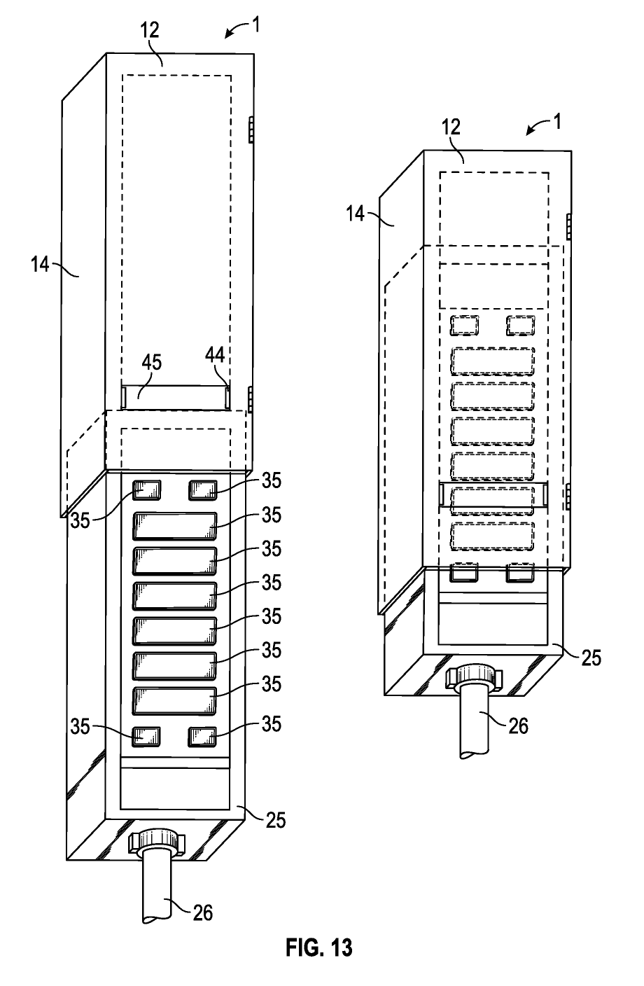

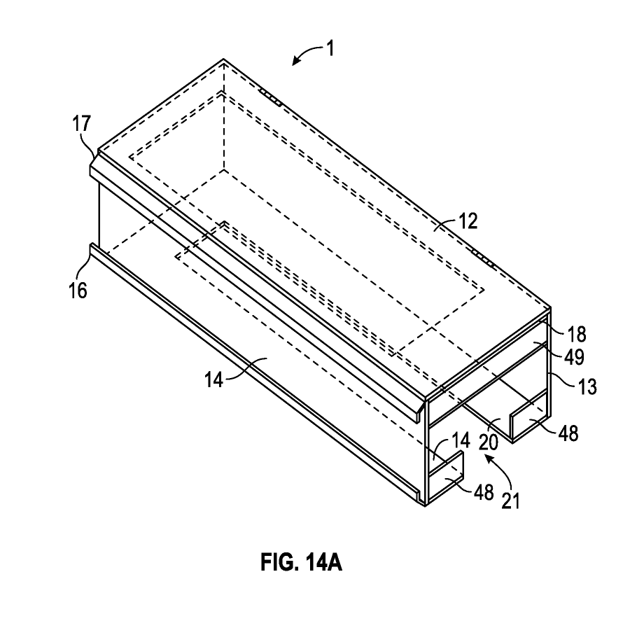

As best seen in FIG. 12, in exemplary embodiments the film 44 is in rolled form, pre-loaded into the applicator 45. Thus, in exemplary embodiments one can simply place the remote control 25 into the cover 1, and the motion of installation also installs the film 44 as it is “rolled” onto the remote surface, as shown in FIG. 13. This film feature advantageously provides a dual purpose: a single motion for both installation of the cover as well as the film and making the cover “one-time use only,” because in exemplary embodiments the applicator can only dispense one film before it is deactivated.

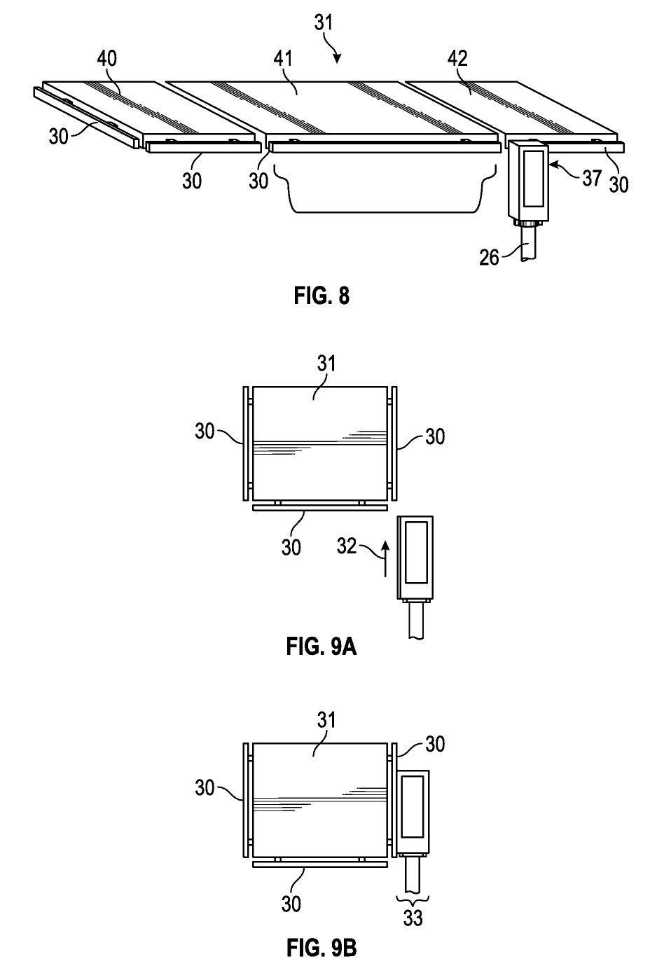

Turning to FIGS. 8-10, a remote control housing system and method will be described. As shown in FIG. 8, a surgical table or bed 31 may have multiple adjustable panels 40, 41, 42 and railing 30 running around most or all of the bed 31. For purposes of this disclosure “side rail” means any portion of the railing running around a surgical bed or table 31, whether at the head, foot, or sides of the table. In exemplary embodiments, side rails 30 may be of the following dimensions: 2.7 cm in height by 1.0 cm in width or 23 cm in length by 3.8 cm in height by 6.5 cm in width. However, any dimensions are possible and may vary in different circumstances as known in the art.

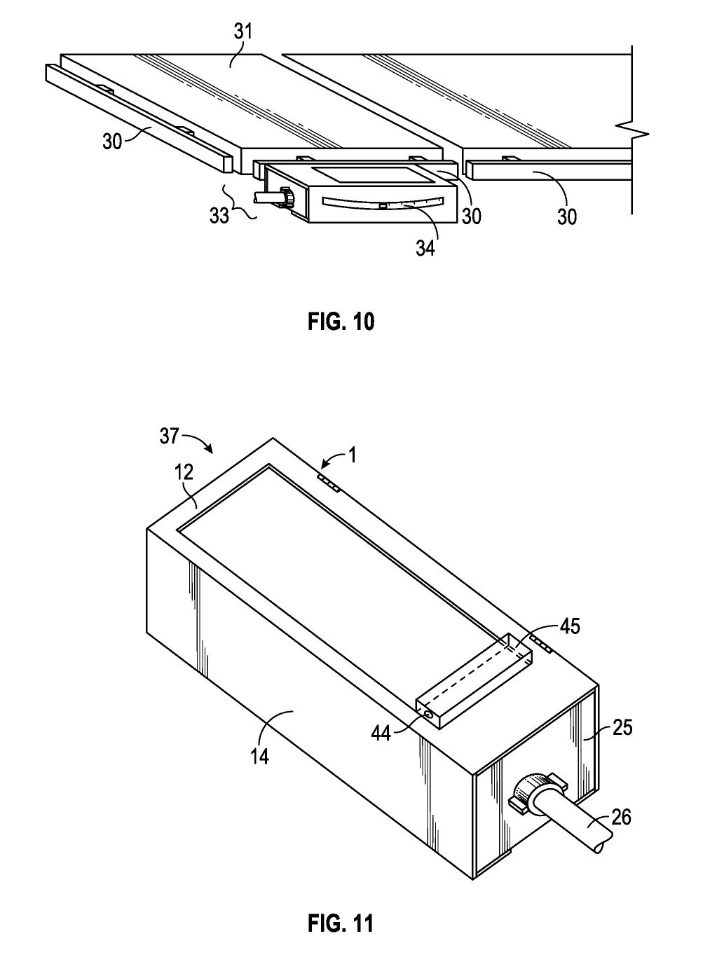

In operation, the protective remote-cover unit 37 can be fastened to the surgical bed 31 via clip 27 on the posterior face 43 of the remote 25. This arrangement is shown in FIG. 8, though the clip and posterior face of the remote are not visible in this view. In FIGS. 9A-9B, the sliding functionality 32 of the remote-cover unit 37 to a side rail 30 of the surgical bed 31 can be seen. To slidably couple the remote-cover unit 37 to the surgical bed or table 31, the user grasps the remote-cover unit 37 and holds it so the rail slot 29 is aligned with an edge of a side rail 30. More particularly, the user holds the remote-cover unit 37 so the first overhang 16 is aligned with a top surface of the edge of the side rail 30 and the second overhang 17 is aligned with a bottom surface of the edge of the side rail. The user then moves the remote-cover unit 37 in the direction of the side rail so the rail slot 29 slides over the side rail 30, with the side rail 30 within the rail slot 29, until the remote-cover unit 37 is fully and securely installed on the side rail 30 of the surgical bed 31, as shown in FIG. 10.

The remote control 25, protective cover 1, and surgical bed side rail 30 form a remote control housing system or unit 33 which facilitates the use of the remote control 25 without lifting the remote itself. As shown in FIG. 10, a measuring scale 34 may be located on a lateral wall of the remote control and may use gravity to measure the degree of top-bottom rotation is present on the surgical bed relative to the operating room floor. To remove the remote-cover unit 37, the user grasps the unit 37 in one hand and slides it in the opposite direction until the rail slot 29 slides off and disengages from side rail 30.

In exemplary embodiments, the protective cover-remote control unit 37 has the ability to attach itself to the surgical bed side rail 30 through a left-sided sliding mechanism. This allows the provider to use the remote control 25 without holding it and provides the ability to quantify patient positioning relative to the OR floor. In addition, the remote control can be installed into the protective cover if a sterile cover (e.g., Cone Instruments, Caledonia, Mich. product #934436) may be placed on it, in circumstances which the remote control is needed to be controlled by those in the sterile field (i.e. surgeon, surgical tech, or nurse).

Thus, it is seen that remote control housing systems, devices, and methods, and protective covers for remote control units used in medical procedures are provided. While the systems, devices, and methods have been described in terms of exemplary embodiments, it is to be understood that the disclosure need not be limited to the disclosed embodiments. Although illustrative embodiments are described hereinabove, it will be evident to one skilled in the art that various changes and modifications may be made therein without departing from the disclosure.

It should be understood that any of the foregoing configurations and specialized components or chemical compounds may be interchangeably used with any of the systems of the preceding embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims. It is intended in the appended claims to cover all such changes and modifications that fall within the true spirit and scope of the disclosure.

What is claimed is:

1. A cover device for a remote control device, comprising:
an anterior wall defining a central opening therein;
a posterior wall formed of two ledges and defining a gap therein;
a first lateral wall connected to the anterior wall and the posterior wall;
a second lateral wall connected to the anterior wall and the posterior wall;
a superior wall connected to the anterior wall, the posterior wall, the first lateral wall, and the second lateral wall; and
a door hingedly connected to the anterior wall.

2. The cover device of claim 1 further comprising two overhangs connected to one of the lateral walls.

3. The cover device of claim 2 wherein the two overhangs define a rail slot.

4. The cover device of claim 3 wherein the rail slot is sized to accommodate a surgical bed side rail.

5. The cover device of claim 1 wherein the gap is sized to accommodate a clip on a remote control device.

6. The cover device of claim 5 further comprising a remote control device for a surgical table.

7. The cover device of claim 6 wherein the remote control device is slidably insertable into the cover device.

8. The cover device of claim 3 further comprising a surgical bed having at least one side rail.

9. The cover device of claim 8 wherein the cover device is slidably attachable to the side rail via the rail slot.

10. The cover device of claim 1 wherein one or more of the anterior wall, posterior wall, lateral walls, and door are made of a sterile material.

11. A remote control housing system comprising:
a remote control cover device including an anterior wall defining a central opening therein, a posterior wall including two ledges and defining a gap therein, a first lateral wall connected to the anterior wall and the posterior wall, a second lateral wall connected to the anterior wall and the posterior wall, a superior wall connected to the anterior wall, the posterior wall, the first lateral wall, and the second lateral wall, a door hingedly connected to the anterior wall, and two overhangs connected to one of the lateral walls, the overhangs defining a rail slot; and
a surgical bed having at least one side rail, the remote control cover device being slidably attachable to the side rail via the rail slot.

12. The system of claim 11 further comprising a remote control device that is slidably insertable into the remote control cover device.

13. The system of claim 12 wherein the remote control device has a posterior wall and comprises a clip attached to its posterior wall.

14. The system of claim 13 wherein the gap is sized to accommodate the clip.

15. A method of using a remote control device, comprising:
providing a remote control cover device including an anterior wall defining a central opening therein, a posterior wall including two ledges and defining a gap therein, a first lateral wall connected to the anterior wall and the posterior wall, a second lateral wall connected to the anterior wall and the posterior wall, a superior wall connected to the anterior wall, the posterior wall, the first lateral wall, and the second lateral wall, a door hingedly connected to the anterior wall, and two overhangs connected to one of the lateral walls, the overhangs defining a rail slot; and
coupling the remote control cover device to a surgical bed having at least one side rail by sliding the rail slot onto the side rail.

16. The method of claim 15 further comprising sliding a remote control device into the remote control cover device.

17. The method of claim 16 further comprising opening the door of the remote control cover device.

18. The method of claim 17 further comprising activating one or more buttons of the remote control device to move the surgical bed.
